(19) United States
(12) Patent Application Publication
(10) Pub. No.: US 2011/0113624 A1
(43) Pub. Date: May 19, 2011

(54) SHEET BONDING DEVICE AND SHEET BONDING METHOD

(75) Inventor: Tohru Harada, Kawasaki (JP)

(73) Assignee: FUJITSU LIMITED, Kawasaki-shi (JP)

(21) Appl. No.: 12/944,226

(22) Filed: Nov. 11, 2010

(30) Foreign Application Priority Data
Nov. 13, 2009 (JP) 2009-259500

(51) Int. Cl. H01R 43/00; B23P 19/00

(52) U.S. Cl. 29/825; 29/729

(57) ABSTRACT

A sheet bonding device includes a detection unit that detects first position data of first marks in a first sheet provided with a first electrode, and second position data of second marks in a second sheet provided with a second electrode, a generation unit that generates third shape data from the first shape data based on a result of comparison of the first position data and the third position data, and generates fourth shape data from the second shape data based on a result of comparison of the second position data and the fourth position data, and a decision unit that changes relative positions of the third shape data and the fourth shape data, and determines a first relative position of the first electrode against the second electrode at which an area of overlapping in plan view of the third shape data and the fourth shape data is maximized.

### CROSS-REFERENCE TO RELATED APPLICATIONS

This application is based upon and claims the benefit of priority of the prior Japanese Patent Application No. 2009-259500, filed on Nov. 13, 2009, the entire contents of which are incorporated herein by reference.

### FIELD

The embodiments discussed herein are related to a sheet bonding device and a sheet bonding method capable of bonding two sheets provided with electrodes together.

### BACKGROUND

An electronic paper is manufactured by bonding a pair of electrode sheets together. The electrode sheets are mainly made of resin, and thus expansion or contraction occurs therein due to change in temperature, humidity, or the like. As a result, electrode patterns formed on the electrode sheets are distorted due to the expansion or contraction of the electrode sheets.

In a liquid crystal panel or a plasma display panel where electrode sections are patterned on a glass, it is not desired to have the aforementioned expansion and contraction. For example, an electronic paper and a liquid crystal panel which are made of resin may be deteriorated in quality due to distortion caused in a manufacturing process which is premised on the use of glass.

Japanese Laid-open Patent Publication No. 2005-43424 discloses a technique where electrode patterns are selected or changed depending on expansion and contraction of substrates.

### SUMMARY

According to an embodiment, a sheet bonding device includes a detection unit that detects first position data of a plurality of first marks in a first sheet provided with a first electrode, and second position data of a plurality of second marks in a second sheet provided with a second electrode, an obtaining unit that obtains design data regarding first shape data of the first electrode in the first sheet, third position data of the plurality of first marks in the first sheet, second shape data of the second electrode in the second sheet, and fourth position data of the plurality of second marks in the second sheet, a generation unit that generates third shape data of the first electrode from the first shape data based on a result of comparison of the first position data and the third position data, and generates fourth shape data of the second electrode from the second shape data based on a result of comparison of the second position data and the fourth position data, a decision unit that changes relative positions of the third shape data and the fourth shape data, and determines a first relative position of the first electrode against the second electrode at which an area of overlapping in plan view of the third shape data and the fourth shape data is maximized, a movement unit that moves at least one of the first sheet and the second sheet to a moved position based on the first relative position, and a bonding unit that bonds the first sheet and the second sheet together at the moved sheet position

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates sheets included in an electronic paper.

FIG. 2 illustrates a lower sheet of the electronic paper.

FIG. 3 illustrates an upper sheet of the electronic paper.

FIG. 4 is a plan view showing all stacked layers (hereinafter referred to as a transmissive view) illustrating a structure of the electronic paper.

FIG. 5 is a transmissive view illustrating the electronic paper where the lower sheet and the upper sheet are bonded together with a correct positional relationship.

FIG. 6 is a transmissive view illustrating a misaligned electronic paper where the lower sheet and the upper sheet are bonded together with an incorrect positional relationship.

FIG. 7 is a block diagram illustrating a configuration of a sheet bonding device.

FIG. 8 is a schematic view of the sheet bonding device.

FIG. 9 is a flowchart illustrating an operation of the sheet bonding device.

FIG. 10 is a flowchart illustrating a process of creating electrode pattern data.

FIG. 11 is a plan view illustrating an actual lower sheet.

FIG. 12 illustrates data representing an electrode pattern before deformation.

FIG. 13 illustrates data representing the electrode pattern after deformation in the transverse direction.

FIG. 14 illustrates data representing the electrode pattern after deformation in the longitudinal direction.

FIG. 15 is a flowchart illustrating a process of determining an optimum or enhanced position.

FIG. 16 is another block diagram of a sheet bonding device.

### DESCRIPTION OF EMBODIMENTS

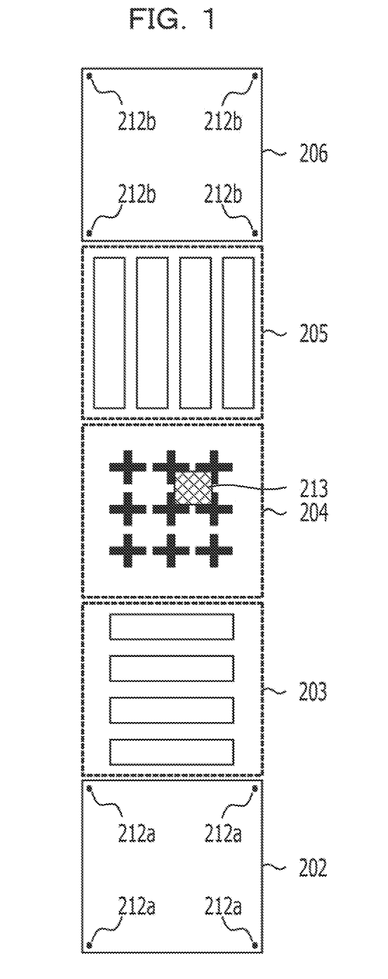

Hereinafter, a structure of an electronic paper 201 having a wall structure will be described. FIG. 1 is a plan view illustrating sheets included in the electronic paper 201. The electronic paper 201 has a substantially rectangular shape in plan view. The electronic paper 201 includes a lower transparent sheet (or layer) 202, a lower electrode section sheet 203, a wall sheet 204, an upper electrode section sheet 205, and an upper transparent sheet 206. These are stacked in this order from the bottom to form the electronic paper 201. The lower electrode section sheet 203 includes a plurality of electrodes arranged in parallel to each other and extending in the transverse direction. The upper electrode section sheet 205 includes a plurality of electrodes arranged in parallel to each other and extending in the longitudinal direction. The lower transparent sheet 202 and the upper transparent sheet 206 are mainly made of resin.

Alignment markings (or marks) 212a and 212b are respectively provided at specific positions around the corners of the lower transparent sheet 202 and the upper transparent sheet 206. The alignment marks 212a in the lower transparent sheet 202 have, for example, a solid cross shape, and the alignment marks 212b in the upper transparent sheet 206 have, for example, an unfilled cross shape. Thereby, when the alignment marks 212a in lower transparent sheet 202 and the alignment marks 212b in the upper transparent sheet 206 overlap each other, they may be distinguished from each other, and their respective positions may be detected.

The wall sheet 204 has a plurality of columns which provides support between the lower electrode section sheet 203 and the upper electrode section sheet 205. Each of columns has a cross shape. The plurality of columns is arranged in a matrix at substantially the same interval. In addition, the wall sheet 204 has a plurality of square spaces in a plan view which do not cover electrodes between the columns. This space forms a square inter-wall region 213 between the columns in the lower electrode section sheet 203. The shape of the inter-wall region 213 may be any other shape such as rectangular. A plurality of inter-wall regions 213 is arranged in a matrix at substantially the same interval. The shaded region in the wall sheet 204 in the drawing, which illustrates the sheets included in the electronic paper 201, shows one inter-wall region 213.

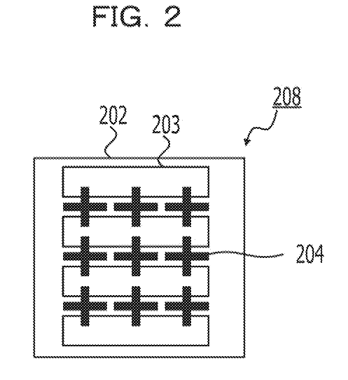

In the manufacturing process of the electronic paper 201, the lower electrode section sheet 203 is provided on the lower transparent sheet 202, and the wall sheet 204 is provided on the lower electrode section sheet 203, thereby forming a lower sheet 208. FIG. 2 is a plan view illustrating the lower sheet 208 of the electronic paper 201.

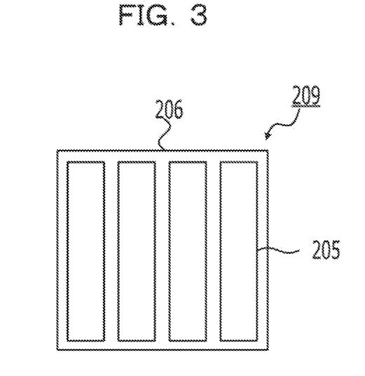

In the manufacturing process of the electronic paper 201, along with the formation of the lower sheet 208, the upper electrode section sheet 205 is provided on the upper transparent sheet 206 to form an upper sheet 209. FIG. 3 is a bottom view illustrating the upper sheet 209 of the electronic paper 201. The wall sheet 204 may be disposed to form an uppermost layer of the lower sheet 208, or instead, may be disposed to form a lowermost layer of the upper sheet 209.

In the manufacturing process of the electronic paper 201, the lower sheet 208 and the upper sheet 209 are separately formed, and then the lower sheet 208 and the upper sheet 209 are bonded together to form the electronic paper 201.

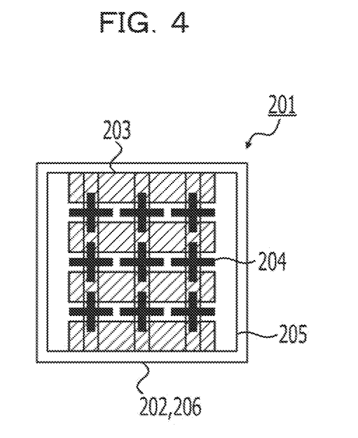

FIG. 4 is a transmissive view illustrating a structure of the electronic paper 201. The electronic paper 201 is formed by bonding the lower sheet 208 and the upper sheet 209 together. After the bonding, liquid crystal is filled between the lower electrode section sheet 203 and the upper electrode section sheet 205 and then sealed. After the sealing, voltages are applied from an external source between the lower electrode section sheet 203 and the upper electrode section sheet 205 to control the liquid crystal.

In the state where the lower sheet 208 is formed, a region where the lower electrode section sheet 203 overlaps an inter-wall region 213 forms an inter-wall lower electrode region. Then, in the state where the lower sheet 208 and the upper sheet 209 are bonded together, a region where the upper electrode section sheet 205 overlaps an inter-wall region 213 forms an inter-wall upper electrode region. A region where the inter-wall lower electrode region and the inter-wall upper electrode region overlap each other is a pixel region. A plurality of the inter-wall lower electrode regions and a plurality of respective inter-wall upper electrode regions overlap to form a plurality of pixel regions. When a region where an inter-wall lower electrode region and an inter-wall upper electrode region overlap each other forms a plurality of regions, a region having the largest area of the plurality of regions is a pixel region. One pixel region corresponds to one pixel of the electronic paper 201. One pixel region may be a region including at least one of an inter-wall lower electrode region and a corresponding inter-wall upper electrode region as viewed along normal direction.

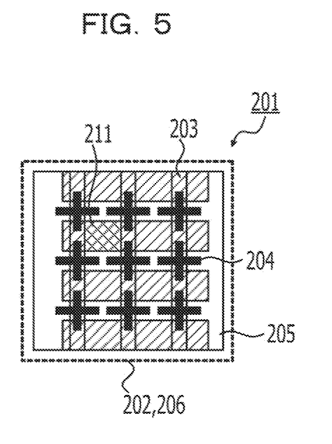

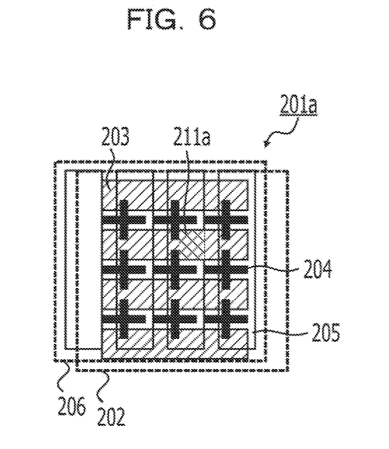

FIG. 5 is a transmissive view illustrating the electronic paper 201 where the lower sheet 208 and the upper sheet 209 are bonded together with a correct positional relationship. In the electronic paper 201 in the drawing, regions marked with the diagonal lines indicate a lower electrode, and the shaded region indicates one pixel region 211. FIG. 6 is a transmissive view illustrating a misaligned electronic paper 201a where the lower sheet 208 and the upper sheet 209 are bonded together with an incorrect positional relationship. In the electronic paper 201a in the drawing, regions marked with diagonal lines indicate the lower electrode section sheet 203, and the shaded region indicates a pixel region 211a.

If the electronic paper 201 is compared with the electronic paper 201a, the area of the pixel region 211a in the electronic paper 201a is smaller than the area of the pixel region 211 in the electronic paper 201. The area of the pixel region 211a is smaller than a normal value, and thus liquid crystal of the electronic paper 201a enters a state where a normal voltage is not applied to the liquid crystal. This state causes the electronic paper 201a not to be displayed normally or the electronic paper 201a to leave afterimages.

Since the lower transparent sheet 202 and the upper transparent sheet 206 are mainly made of resin, expansion and contraction is generated in the lower sheet 208 and the upper sheet 209. When the expanded and contracted sheets are bonded together, the sheets having distortion are bonded together, and the distortions in both sheets are not limited to being substantially the same as each other.

There are cases where an electronic paper with a single region is obtained from one electronic paper 201 and where electronic papers with a plurality of partial regions are cut and obtained from one electronic paper 201 (chamfering). Design data for the electronic paper 201 includes a structure of each of the lower sheet 208 and the upper sheet 209 and a position of an obtained region.

Hereinafter, a position decision method of deciding an optimum or enhanced relative position when the lower sheet 208 and the upper sheet 209 are bonded together will be described.

In the position decision method in this embodiment, a position where the area in which the overlapping of the lower sheet 208 and the upper sheet 209 with each other is maximized is not desired, but a position where the area of the pixel regions is maximized is desired. In this position decision method, expansion and contraction of sheets is measured, and arrangement data is created based on a measured result.

Hereinafter, a sheet bonding device 100 according to an embodiment will be described.

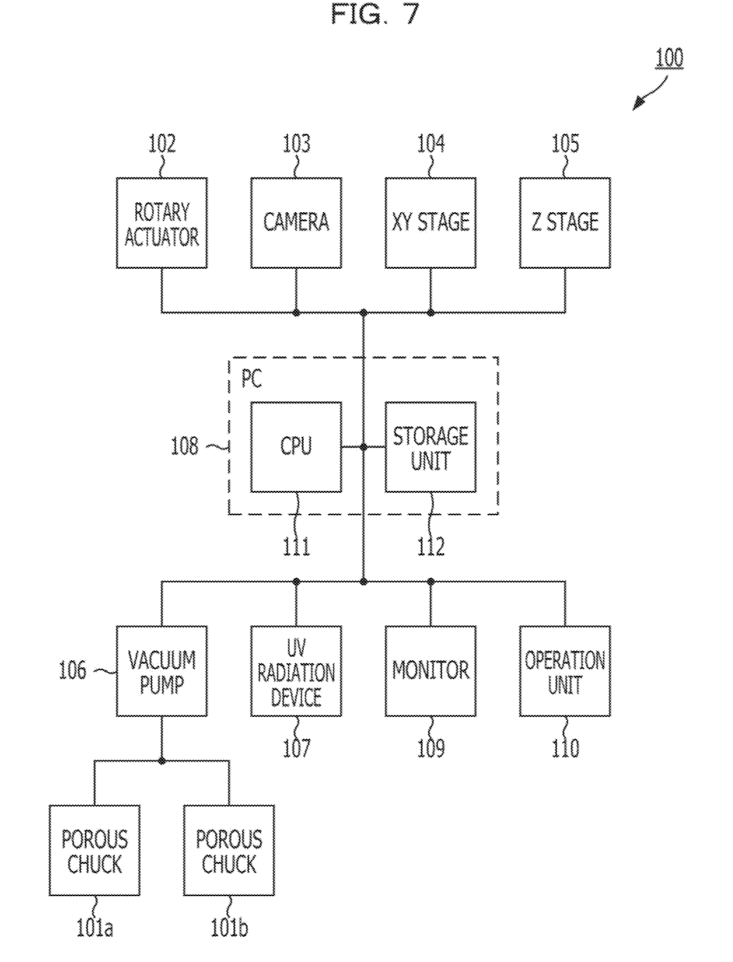

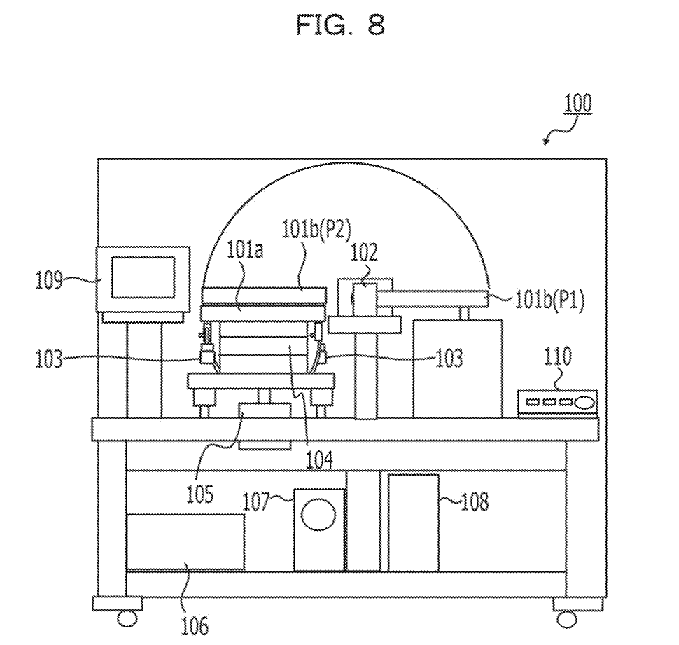

FIG. 7 is a block diagram illustrating a configuration of a sheet bonding device 100. FIG. 8 is a schematic view illustrating the configuration of the sheet bonding device 100.

The sheet bonding device 100 includes a porous chuck 101a which sucks the lower sheet 208, a porous chuck 101b which sucks the upper sheet 209, a rotary actuator 102 which overlaps the lower sheet 208 and the upper sheet 209, a camera 103 which photographs a specific position where the lower sheet 208 or the upper sheet 209 is placed, an XY stage 104 which performs horizontal alignment of the porous chuck 101a, a Z stage 105 which applies upward pressure to the porous chuck 101a when sheets are bonded together, a vacuum pump 106 which helps the porous chucks 101a and 101b to suck sheets, a UV irradiation device 107 which irradiates UV (ultraviolet) light and cures adhesive applied on a closely attached surface of each sheet in order to prevent misalignment of two closely-attached sheets, a PC (personal computer) 108 which performs control for each mechanism and image processing, a monitor 109 which displays processed messages or camera images to a worker depending on an instruction from the PC 108, and an operation unit 110 for operating the PC 108 and the like.

The PC 108 has a CPU (central processing unit) 111 and a storage unit 112. The storage unit 112 stores a sheet bonding program. The CPU 111 makes the sheet bonding device 100 perform operations according to the sheet bonding program stored in the storage unit 112.

The storage unit 112 stores design data for the lower sheet 208 and the upper sheet 209. The lower sheet 208 and the upper sheet 209 are formed based on the design data.

Before and after an operation of the sheet bonding device 100, the porous chuck 101b is disposed at an initial position P1 which is a position spaced apart from the porous chuck 101a, with its sucking surface upwards. When the lower sheet 208 and the upper sheet 209 are bonded together, the porous chuck 101b is disposed at a bonded position P2, where its sucking surface faces a sucking surface of the porous chuck 101a, by the rotation of the rotary actuator 102 which supports the porous chuck 101b.

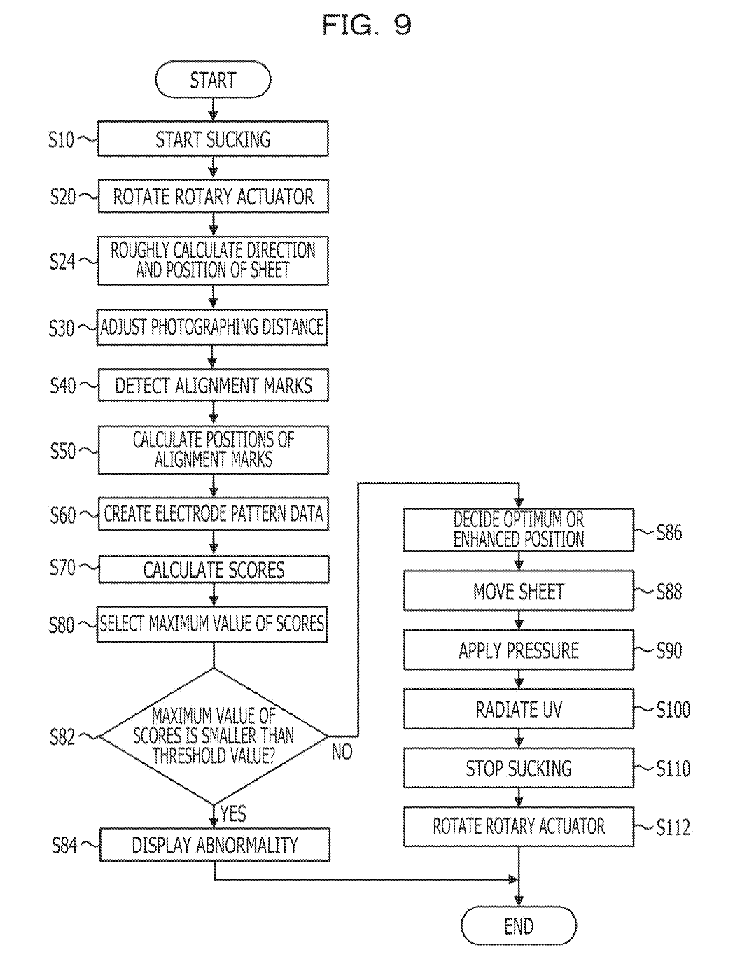

FIG. 9 is a flowchart illustrating an operation of the sheet bonding device 100.

The PC 108 makes the porous chuck 101a start to suck the lower sheet 208, and the porous chuck 101b start to suck the upper sheet 209 (S10). The lower sheet 208 is set on the porous chuck 101a by a worker. The upper sheet 209 is set on the porous chuck 101b by a worker.

The PC 108 rotates the rotary actuator 102 in a direction where the porous chuck 101a and the porous chuck 101b are closed. By this rotation, the rotary actuator 102 moves the porous chuck 101b from the position P1 to the position P2 on the porous chuck 101a (S20).

The PC 108 reads the design data from the storage unit 112. The PC 108 makes the camera 103 photograph the vicinities of the alignment marks 212a and 212b marked around the corners of the sheets, and detects the alignment marks 212a and 212b based on an image obtained from the camera 103. The PC 108 roughly calculates directions and positions of the set sheets based on the positions of the detected alignment marks 212a and 212b (S24).

The PC 108 makes the camera 103 photograph the alignment marks 212a and 212b, the Z stage 105 moves upwards until the alignment marks 212a and 212b enter the focal depth, and the porous chuck 101a and the porous chuck 101b approach each other (S30).

The PC 108 makes the camera 103 photograph the alignment marks 212a and 212b and detects the alignment marks 212a and 212b on the lower sheet 208 and the upper sheet 209 based on an image obtained from the camera 103, by the camera 103 (S40).

The PC 108 calculates positions of the alignment marks 212a and 212b in the design data and positions of the detected alignment marks 212a and 212b (S50).

The PC 108 deforms a shape of the lower sheet 208 which is based on the read design data, based on the positions of alignment marks 212a in the design data and the calculated alignment marks 212a, and creates electrode pattern data A indicating a shape of the deformed lower sheet 208 and a shape of the electrode pattern thereon. In substantially the same manner, the PC 108 deforms the upper sheet 209 based on the positions of the alignment marks 212b in the design data and the calculated alignment marks 212b, and creates electrode pattern data B indicating a shape of the deformed upper sheet 209 and the electrode pattern thereon (S60).

The PC 108 decides a position P where the electrode pattern data A is virtually attached to a current position of the electrode pattern data B, and calculates a score when the electrode pattern data A at the virtually attached position P and the electrode pattern data B at the current position are bonded together. The PC 108 changes the virtually attached position P in a specific range, repeatedly calculates the score, and stores a set of the virtually attached positions P and the score in the storage unit 112 (S70). The score indicates the area size of a pixel region. As the area of a pixel region increases, the score becomes greater.

The PC 108 selects the maximum score of the plurality of stored scores (S80). The PC 108 determines whether or not the selected maximum score is smaller than a reference score threshold value (S82).

If the selected score is smaller than the reference score threshold value (S82, Y), the PC 108 determines that bonding of the lower sheet 208 and the upper sheet 209 is abnormal, displays the abnormality on the monitor 109 (S84), and then finishes the flow.

If the selected score is greater than the reference score threshold value (S82, N), the PC 108 determines that a virtually attached position P corresponding to the selected score is an optimum or enhanced position Q (S86).

The PC 108 moves the XY stage 104 to the optimum or enhanced position Q and thus moves the lower sheet 208 to the optimum or enhanced position Q (S88).

The PC 108 moves the Z stage 105 upwards to closely attach the lower sheet 208 and the upper sheet 209 to each other, and further applies a certain pressure to the lower sheet 208 and the upper sheet 209 (S90).

The PC 108 makes the UV irradiation device 107 irradiate UV (S100). By this irradiation, adhesives applied in advance on an upper surface of the lower sheet 208 and a lower surface of the upper sheet 209 are cured, and the misalignment of the lower sheet 208 and the upper sheet 209 is substantially prevented.

The PC 108 stops the sucking of the porous chuck 101a and the porous chuck 101b (S110). The PC 108 rotates the rotary actuator 102 in a direction where the porous chuck 101a and the porous chuck 101b are opened. By this rotation, the rotary actuator 102 moves the porous chuck 101b from the position P2 to the initial position P1 (S112).

As above, the PC 108 finishes the flow.

The bonding of the lower sheet 208 and the upper sheet 209 by the UV irradiation (S100) may be permanent or temporary. If the bonding is temporary, after the bonded position is checked again, another bonding device permanently bonds the lower sheet 208 and the upper sheet 209 together.

In the above-described embodiment, although the sheet bonding device 100 decides the optimum or enhanced position of the lower sheet 208 and then moves the lower sheet 208 to the optimum or enhanced position, the sheet bonding device 100 may decide an optimum or enhanced position of the upper sheet 209 and then move the upper sheet 209 to the optimum or enhanced position.

Hereinafter, a detailed example of the creation of the electrode pattern data (S60) will be described.

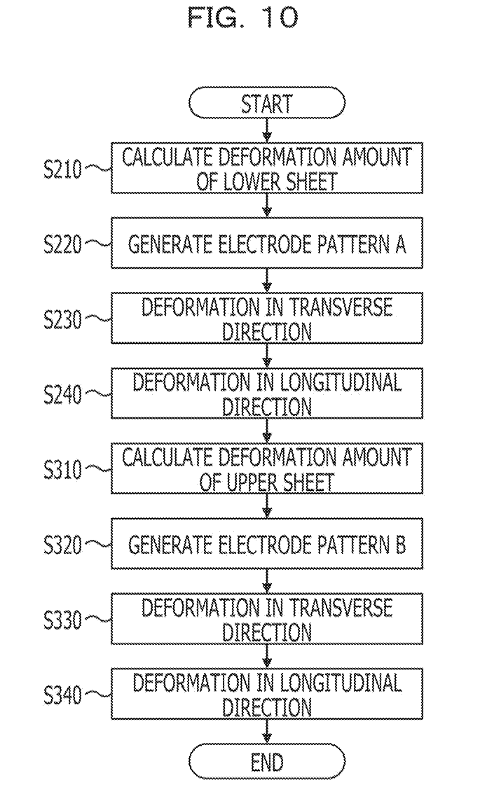

FIG. 10 is a flowchart illustrating a process of creating electrode pattern data.

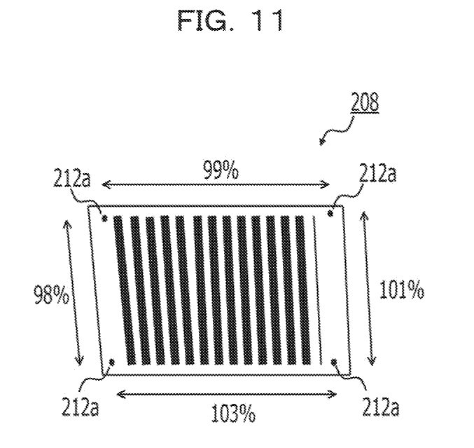

The PC 108 calculates the deformation amount of an actual lower sheet 208 based on the positions of alignment marks 212a at the four corners detected from the image obtained from the camera 103 (S210). Here, the PC 108 calculates a length of each side of a rectangle having the four alignment marks 212a on the lower sheet 208 as vertices. FIG. 11 is a plan view illustrating an example of the detected lower sheet 208. This drawing illustrates an example of a ratio of expansion and contraction of each side of the detected rectangle. Here, the ratio of expansion and contraction is (the length of an actual side)/(the length of a side in the design data). In this example, the ratio of expansion and contraction for the length of the upper side is 99%, the ratio of expansion and contraction for the length of the lower side is 103%, the ratio of expansion and contraction for the length of the left side is 98%, and the ratio of expansion and contraction for the length of the right side is 101%.

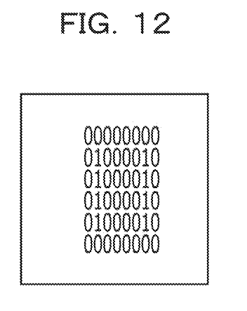

The PC 108 reads design data for the lower sheet 208 stored in the storage unit 112, and generates the electrode pattern data A which is two-dimensional arrangement data indicating a shape excluding portions covered by the wall sheet 204 from the electrode patterns of the lower sheet 208 shown in the design data (S220). The design data indicates, for example, a coordinate of each vertex of the electrode patterns. The electrode pattern data A is a binary image having each element as a pixel. In other words, the electrode pattern data A is a matrix having a value of each element as 0 or 1. The size of an element in the electrode pattern data A is, for example, 1 μm×1 μm. FIG. 12 illustrates an example of the electrode pattern data A before deformation. In the design data, a pixel value corresponding to a position where electrodes are absent is 0, and a pixel value corresponding to a position where electrodes are present is 1.

The PC 108 deforms the electrode pattern data A in the transverse direction (X direction) based on the length of the upper side and the length of the lower side of the actual lower sheet 208 (S230). Here, the PC 108 designates, in the matrix of the electrode pattern data A, the length of the upper side as the length of the upper end row, and the length of the lower side as a length of the lower end row. The PC 108 linearly interpolates the length of the upper end row and the length of the lower end row and calculates a target length of each row between the upper end row and the lower end row. The PC 108 performs insertion or removal of elements for each row of the electrode pattern data A, or maintains the current state, depending on the calculated target length of each row. Thereby, the PC 108 deforms the electrode pattern data A in the transverse direction.

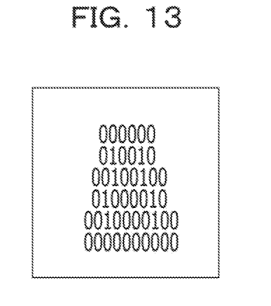

FIG. 13 illustrates an example of the electrode pattern data A after deformation in the transverse direction. This example illustrates a case where the ratio of expansion and contraction for the upper side is smaller than 100%, and the ratio of expansion and contraction for the lower side is greater than 100%. Thus, upon comparison with the electrode pattern data A before deformation, the length of the row in the electrode pattern data A after deformation in the transverse direction is shorter in the upper side, and is longer in the lower side. The PC 108 inserts the number of elements corresponding to the target length into rows larger than 100% in the ratio of expansion and contraction at a substantially constant interval. The PC 108 removes the number of elements corresponding to the target length from rows smaller than 100% in the ratio of expansion and contraction at a substantially constant interval. The PC 108 does not deform rows having the ratio of expansion and contraction of 100%.

Likewise, the PC 108 deforms the electrode pattern data A in the longitudinal direction (Y direction) based on the length of the left side and the length of the right side of the actual lower sheet 208 (S240). Here, the PC 108 designates, in the matrix of the electrode pattern data A, the length of the left side as a length of the left end column and the length of the right side as a length of the right end column. The PC 108 linearly interpolates the length of the left end column and the length of the right end column, and calculates a target length of each column between the left end column and the right end column. The PC 108 performs insertion or removal of elements for each column of the electrode pattern data A, or maintains the current state, depending on the calculated target length of each column. Thereby, the PC 108 deforms the electrode pattern data A in the longitudinal direction.

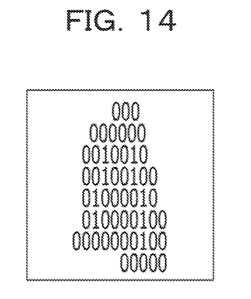

FIG. 14 illustrates an example of the electrode pattern data A after deformation in the longitudinal direction. This example illustrates a case where the ratio of expansion and contraction for the left side is smaller than 100%, and the ratio of expansion and contraction for the right side is greater than 100%. Thus, upon comparison with the electrode pattern data A after deformation in the transverse direction, the length of the column in the electrode pattern data A after deformation in the longitudinal direction is shorter in the left side, and is longer in the right side. The PC 108 inserts the number of elements corresponding to the target length into columns larger than 100% in the ratio of expansion and contraction at a substantially constant interval. The PC 108 removes the number of elements corresponding to the target length from columns smaller than 100% in the ratio of expansion and contraction at a substantially constant interval. The PC 108 does not deform columns having the ratio of expansion and contraction of 100%.

In substantially the same manner as operation S210, the PC 108 calculates the deformation amount of the actual upper sheet 209 based on the positions of the alignment marks 212b at the four corners detected from the image obtained from the camera 103 (S310). Here, the PC 108 calculates a length of each side of a rectangle having the four alignment marks 212b on the upper sheet 209 as vertices.

In substantially the same manner as operation S220, the PC 108 reads design data for the upper sheet 209 stored in the storage unit 112, and generates the electrode pattern data B which is two-dimensional arrangement data indicating a shape of the electrode patterns shown in the design data (S320).

In substantially the same manner as operation S230, the PC 108 deforms the electrode pattern data B in the transverse direction based on the length of the upper side and the length of the lower side of the actual upper sheet 209 (S330).

In substantially the same manner as operation S240, the PC 108 deforms the electrode pattern data B in the longitudinal direction based on the length of the left side and the length of the right side of the actual upper sheet 209 (S340).

As above, the PC 108 finishes the flow.

Here, as a detailed example of insertion of elements in the transverse and longitudinal deformation, a case where elements in the longitudinal deformation are inserted with a two-pixel unit will be described. A value of an inserted element is 0. The PC 108 calculates the number of insertions=(calculated target length of each column)−(length of each column before deformation), and converts the number of insertions to have the closest multiple of two pixels. The PC 108 decides an insertion interval=(length of a target column before deformation)/(the number of insertions)/2, and decides an inserted position in a target column at each insertion interval. The PC 108 determines a value of an existing element in the insertion position in the target column. If the value of the element in the inserted position is 0, the PC 108 inserts two inserted elements of 0 into the inserted position. If the value of the element in the inserted position is 1, the PC 108 inserts each inserted element of 0 into both ends of electrodes having the element of 1 (consecutive elements of 1).

In the above-described example of creation of the electrode pattern data, the deformation of the electrode pattern data may be performed by the PC 108 in the order of the transverse direction and the longitudinal direction; however, it may be in an order of the longitudinal direction and the transverse direction.

In the creation of the above-described electrode pattern data, a value of the inserted element may be a value of an existing element in an inserted position.

In the creation of the above-described electrode pattern data, the PC 108 may perform a two-dimensional deformation for the design data. For example, if the design data includes a coordinate of each vertex of the electrode patterns, the PC 108 performs a two-dimensional interpolation for a displacement of the detected alignment marks 212a and 212b and thereby calculates a displacement of the coordinate of each vertex of the electrode patterns in the design data. Thereafter, the PC 108 applies the calculated displacement to the coordinate of each vertex of the electrode patterns in the design data, and calculates a coordinate of each vertex of expanded and contracted electrode patterns. The PC 108 generates two-dimensional arrangement data based on the coordinates of each vertex of the calculated electrode patterns, and thereby generates the electrode pattern data A and B.

Hereinafter, a detailed example of deciding an optimum or enhanced position (S70 and S80) will be described.

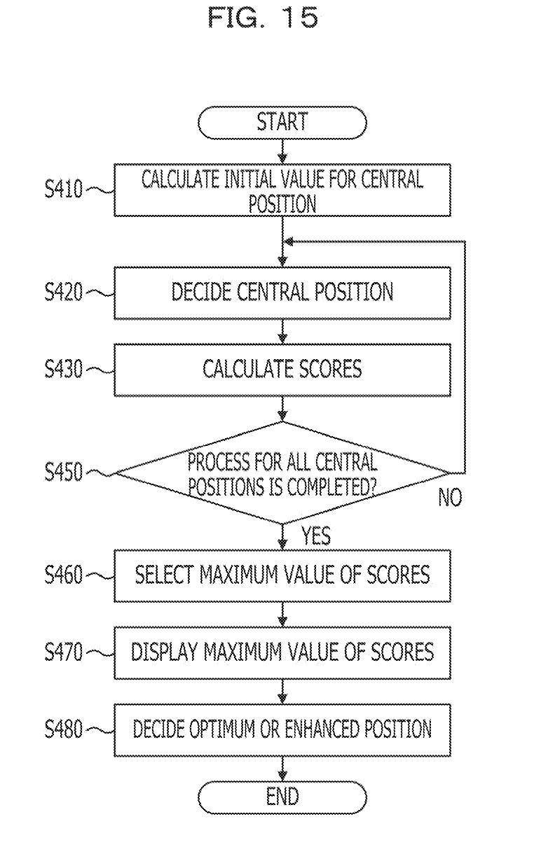

FIG. 15 is a flowchart illustrating a process of determining an optimum or enhanced position.

The PC 108 calculates a current central position G(Gx, Gy) of the four alignment marks 212a on the lower sheet 208 and an initial value H(Hx, Hy) of a current central position of the four alignment marks 212b on the upper sheet 209, respectively (S410).

The PC 108 respectively designates the maximum amount of change in the X direction and Y direction as Mx and My, and respectively designates operations in the X direction and Y direction as Sx and Sy. The maximum amounts of change Mx and My are about 10% of the length of one side of one cell in the electronic paper 201. The PC 108 decides one new central position P(Px, Py) of the electrode pattern data A in a range of movement based on the maximum amounts of change Mx and My and the operations Sx and Sy (S420). Here, the PC 108 changes Px from (Gx−Mx) to (Gx+Mx) pixel-by-pixel, and changes Py from (Gy−maximum amount of change) to (Gy+maximum amount of change) pixel-by-pixel.

The PC 108 moves a center of the electrode pattern data A to the decided position P in the state where a center of the electrode pattern data B is fixed to the initial value H, and calculates a score indicating the area of the overlapping of the electrode pattern data A, the electrode pattern data B, and electrode patterns at the position P (S430). Here, the PC 108 performs an AND operation for elements having the same coordinate in the electrode pattern data A and the electrode pattern data B, and designates a sum total of a result of the AND operation in a specific region as the score. Also, when the design data has a plurality of partial regions, the PC 108 designates each of the plurality of partial regions as the specific region, and calculates the score for each of the plurality of partial regions. When the design data has a single region, the PC 108 designates the single region as the specific region, and calculates the score for the single region. The PC 108 stores the position P and the score corresponding to the position P in the storage unit 112.

The PC 108 determines whether or not the calculation of the scores is completed regarding all of the central positions P in the range of movement (S450).

When the calculation of all the scores is not completed (S450, N), the flow goes to operation S420, and the PC 108 processes a next position P.

When the calculation of all the scores is completed (S450, Y), the PC 108 selects the maximum value of the scores stored in the storage unit 112 (S460). Here, when the design data has a plurality of partial regions, the PC 108 selects the maximum value of all the scores for the plurality of partial regions and the maximum value of the score for the single region. When the design data has a single region, the PC 108 selects the maximum value of the score for the single region. The PC 108 displays the selected maximum value on the monitor 109 (S470).

When the confirmation for the maximum value of the score is input to the operation unit 110 from a user, the PC 108 obtains the confirmation of the maximum value of the score from the operation unit 110, obtains a position P corresponding to the confirmed maximum value of the score from the storage unit 112, and decides the position P as the optimum or enhanced position Q (S480). Here, if both of the maximum value of all the scores for a plurality of partial regions and the maximum value of the score for a single region are displayed on the monitor 109, the confirmation for the maximum value of the score indicates either the maximum value of all the scores for the plurality of partial regions or the maximum value of the score for the single region.

As above, the PC 108 finishes the flow.

By deciding the optimum or enhanced position Q using the maximum value of the score for a single region, it is possible to optimize or enhance characteristics for the single region. When the design data has a plurality of partial regions, it is possible to optimize or enhance all the average characteristics for the plurality of partial regions by deciding the optimum or enhanced position Q using the maximum value of the score for the single value. By deciding the optimum or enhanced position Q using the maximum value of all the scores for the plurality of partial regions, it is possible to optimize or enhance the characteristics of the partial region from which the best characteristics may be obtained, from among the plurality of partial regions.

By displaying both the maximum value of all the scores for a plurality of partial regions and the maximum value of the score for a single region and obtaining an indication of one of them, a user may select whether the quality of products generated from a portion of regions is optimized or enhanced and the remaining regions are not used for products, or whether an average quality of products generated from the respective regions is optimized or enhanced, during the chamfering.

The PC 108 may rotate the electrode pattern data A when moving the electrode pattern data A. In this case, the XY stage 104 has a function of rotation in response to an instruction from the PC 108.

The PC 108 may perform a two-dimensional correlation operation for the electrode pattern data A and the electrode pattern data B, and decide the optimum or enhanced position Q based on a peak position of the operation results.

As a comparative example of the position decision method, there is a method where the actual lower sheet 208 and upper sheet 209 are photographed, positions of electrodes are checked based on an image obtained by the photographing, and the lower sheet 208 and the upper sheet 209 are bonded together. According to the comparative example, there are problems such as increase in costs of manufacturing devices or increase in tact time, or the like, because a line sensor camera for receiving an image of the entire sheet is used in order to confirm the positions of the electrodes.

According to this embodiment, since the PC 108 may easily calculate the electrode pattern data from the design data or drawings for design, it may promptly handle even new design data. According to this embodiment, even if an electronic paper and a liquid crystal panel have complicated electrode patterns, the PC 108 may easily calculate an optimum or enhanced position. Particularly, when the electrode patterns are asymmetric, the PC 108 may perform a process at high speed. According to this embodiment, the PC 108 may perform a process at high speed by using the AND operation in the calculation of the area of overlapping of electrodes.

When electrode patterns may be prepared or changed depending on expansion and contraction, if the number of types of products increases, a large number of mask patterns are desired, and it leads to an increase in costs.

This embodiment may be applied to a device and a method of bonding two sheets, provided with electrode patterns, together. The two sheets provided with electrode patterns may include a resin panel for a liquid crystal panel as well as sheets for the electronic paper.

Hereinafter, a sheet bonding device 300 according to another embodiment will be described.

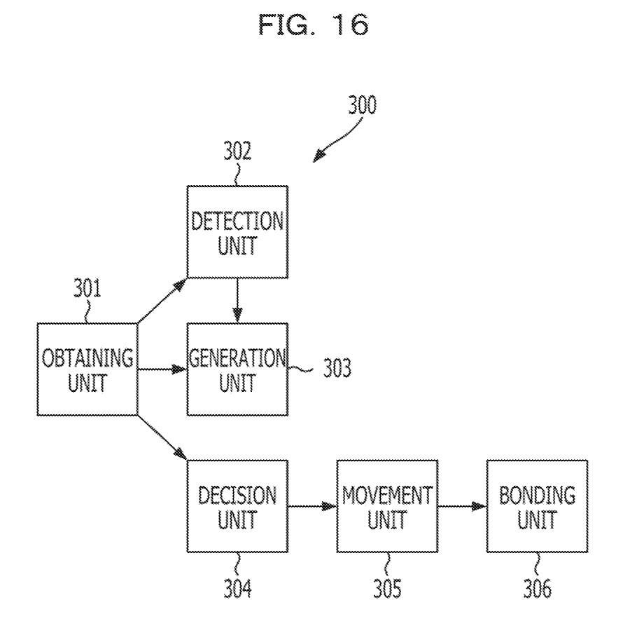

FIG. 16 is a block diagram illustrating a configuration of a sheet bonding device 300.

The sheet bonding device 300 includes an obtaining unit 301, a detection unit 302, a generation unit 303, a decision unit 304, a movement unit 305, and a bonding unit 306. The obtaining unit 301 obtains design data which includes a first shape of a first region in a first electrode, a first position of the first region, third positions of a plurality of first marks associated with the first position, a second shape of a second region in a second electrode, a second position of the second region, and a fourth position of a second mark associated with the second position. The detection unit 302 detects fifth positions of the plurality of first marks from a first sheet where the first region and the plurality of first marks are formed, based on the design data, and detects sixth positions of the plurality of second marks from a second sheet where the second region and the plurality of second marks are formed, based on the design data. The generation unit 303 deforms the first shape to a third shape based on the fifth positions, thereby generating first two-dimensional arrangement data indicating the third shape, and deforms the second shape to a fourth shape based on the sixth positions, thereby generating second two-dimensional arrangement data indicating the fourth shape. The decision unit 304 changes two-dimensional relative positions of the first arrangement data and the second arrangement data, and decides a first relative position which is a relative position at which the area of a third region where the first region in the first arrangement data and the second region in the second arrangement data overlap each other is maximized. The movement unit 305 moves at least one of the first sheet and the second sheet to a sheet position satisfying the first relative position. The bonding unit 306 bonds the first and second sheets together at the moved sheet position.

For example, a function of the obtaining unit 301 is realized by the operation S50 by the PC 108; a function of the detection unit 302 is realized by the operation S40 by the PC 108 with the camera 103, the porous chucks 101a and 101b, and the vacuum pump 106; a function of the generation unit 303 is realized by the operation S60 by the PC 108; a function of the decision unit 304 is realized by the operations S70 to S86 by the PC 108; a function of the movement unit 305 is realized by the operation S84 by the PC 108 with the XY stage 104, the porous chucks 101a and 101b, and the vacuum pump 106; and a function of the bonding unit 306 is realized by the operations S90 to S100 by the PC 108 with the Z stage 105, the UV irradiation device 107, the porous chucks 101a and 101b, and the vacuum pump 106.

For example, the first sheet is the lower sheet 208; the second sheet is the upper sheet 209; the first electrode is the lower electrode section sheet 203; the second electrode is the upper electrode section sheet 205; the first marks are the alignment marks 212a; the second marks are the alignment marks 212b; the first arrangement data is the electrode pattern data A; the second arrangement data is the electrode pattern data B; the first region is the lower electrode section sheet 203; the second region is the upper electrode section sheet 205; the third region is a plurality of pixel regions 211; and the fourth region is a pixel region 211.

For example, the first sheet is the lower transparent sheet 202, the second sheet is the upper transparent sheet 206, the first surface is an upper surface of the lower transparent sheet 202 during bonding, the second surface is a lower surface of the upper transparent sheet 206 during bonding, the supporting member is the wall sheet 204, the unit region is the inter-wall region 213, the specific shape is a square, the display unit is the monitor 109, and the control unit is the PC 108.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Although the embodiments of the present inventions have been described in detail, it should be understood that various changes, substitutions, and alterations could be made hereto without departing from the spirit and scope of the invention.

1. A sheet bonding device comprising:
a detection unit that detects first position data of a plurality of first marks in a first sheet provided with a first electrode, and second position data of a plurality of second marks in a second sheet provided with a second electrode;
an obtaining unit that obtains design data regarding first shape data of the first electrode in the first sheet, third position data of the plurality of first marks in the first sheet, second shape data of the second electrode in the second sheet, and fourth position data of the plurality of second marks in the second sheet;
a generation unit that generates third shape data of the first electrode from the first shape data based on a result of comparison of the first position data and the third position data, and generates fourth shape data of the second electrode from the second shape data based on a result of comparison of the second position data and the fourth position data;
a decision unit that changes relative positions of the third shape data and the fourth shape data, and determines a first relative position of the first electrode against the second electrode at which an area of overlapping in plan view of the third shape data and the fourth shape data is maximized;
a movement unit that moves at least one of the first sheet and the second sheet to a moved position based on the first relative position; and
a bonding unit that bonds the first sheet and the second sheet together at the moved sheet position

2. The sheet bonding device according to claim 1, wherein the decision unit changes two-dimensional relative positions of the first sheet and the second sheet with respect to a central position of the third shape data and a central position of the fourth shape data, respectively.

3. The sheet bonding device according to claim 1, wherein the first sheet is provided with a first layer, the first electrode, and a supporting member;
the first electrode covers a portion of a first surface of the first layer; the supporting member covers a portion of the first surface and the first electrode and has a plurality of regions which is a space with a specific shape on the first surface which is not covered by the supporting member; the second sheet is provided with a second layer and the second electrode; and the second electrode covers a portion of a second surface of the second layer.

4. The sheet bonding device according to claim 1, wherein the detection unit generates an image of the first sheet by photographing the first sheet, detects the first position data based on the image of the first sheet, generates an image of the second sheet by photographing the second sheet, and detects the second position data based on the image of the second sheet.

5. The sheet bonding device according to claim 1, wherein the generation unit generates first arrangement data indicating the first shape, generates second arrangement data by changing the number of elements of the first arrangement data based on the first position data and the third position data, generates third arrangement data indicating the second shape, and generates fourth arrangement data by changing the number of elements of the third arrangement data based on the second position data and the fourth position data, and the decision unit decides the first relative position based on the second arrangement data and the fourth arrangement data.

6. The sheet bonding device according to claim 1, wherein the first sheet and the second sheet are substantially rectangular, and the first marks are disposed at four corners of the first sheet, and the second marks are disposed at four corners of the second sheet.

7. A sheet bonding method comprising:
detecting first position data of a plurality of first marks in a first sheet provided with a first electrode, and second position data of a plurality of second marks in a second sheet provided with a second electrode;
obtaining design data regarding first shape data of the first electrode in the first sheet, third position data of the plurality of first marks in the first sheet, second shape data of the second electrode in the second sheet, and fourth position data of the plurality of second marks in the second sheet, by a control unit;
generating third shape data of the first electrode from the first shape data based on a result of comparison of the first position data and the third position data, and generating fourth shape data of the second electrode from the second shape data based on a result of comparison of the second position data and the fourth position data, by the control unit;
changing relative positions of the third shape data and the fourth shape data;
determining a first relative position of the first electrode against the second electrode at which the area of overlapping in plan view of the third shape data and the fourth shape data is maximized, by the control unit;
moving at least one of the first sheet and the second sheet to a moved position based on the first relative position; and
bonding the first sheet and the second sheet together at the moved sheet position.
